(19) United States
(12) Patent Application Publication
(10) Pub. No.: US 2026/0109297 A1
(43) Pub. Date: Apr. 23, 2026

(54) RAILING ASSEMBLY FOR FLATBED TRAILER WITH WALKING PLATFORM

(71) Applicant: David B. Gunsberg, Oak Park, MI (US)

(72) Inventor: David B. Gunsberg, Oak Park, MI (US)

(21) Appl. No.: 19/427,093

(22) Filed: Dec. 19, 2025

Related U.S. Application Data
(63) Continuation-in-part of application No. 19/049,962, filed on Feb. 10, 2025, now Pat. No. 12,522,304.
(60) Provisional application No. 63/645,977, filed on May 13, 2024.

(51) Int. Cl. B60R 3/00; B62D 33/02; B62D 63/08

(52) U.S. Cl. CPC B60R 3/005; B62D 33/0207; B62D 63/08

(57) ABSTRACT

A railing assembly for use with a flatbed trailer is disclosed. The assembly includes cooperative posts extending in an upwardly direction. A plurality of elongated members extends laterally between the cooperable posts. Each of the cooperable posts is supported on a caster system including a plurality of casters enabling rolling movement of the railing assembly relative to a bed of the flatbed trailer. A platform assembly is disposed between the cooperative posts and the bed of the flatbed trailer. The platform assembly is pivotable relative to the cooperative posts between a lowered position for engaging the bed of the flatbed trailer and an elevated position for disengaging the bed of the flatbed trailer.

### RELATED APPLICATIONS

The present application claims priority to co-pending U.S. patent application Ser. No. 19/049,962 filed on Feb. 10, 2025 that claims priority to U.S. Provisional Patent Application No. 63/645,977 filed on May 13, 2024 and to U.S. Provisional Patent Application No. 63/551,783 filed on Feb. 9, 2024, the contents each of which are incorporated herein by reference.

### FIELD OF DISCLOSURE

The present invention relates generally towards a rail assembly for trailers. More specifically, the present invention relates towards a mobile rail assembly for trailers that includes a walking platform.

### BACKGROUND

Ever-evolving health and safety standards for employees has made it increasingly necessary to adopt safety measures to prevent workplace injuries. One such example for increased safety measures is the need to prevent employees from falling off flatbed trailers and the like. A railing system has been developed to attach to such flatbed trailers and is disclosed in U.S. Pat. No. 11,591,029, the contents of which are incorporated herein by reference. The system has proven to enhance employee safety and is adjustable to meet the needs of various sized flatbed trailers. However, using the system is known to be somewhat slow due to installation requirements. Specific instances involve multiple uses on large numbers of trailers loading and offloading and in a single truck bay. Furthermore, it is sometimes necessary to provide additional space for an operator to move adjacent to the flatbed to adjust or secure objects placed upon the flatbed. Therefore, it would be desirable to develop a system that is more quickly adapted for frequent use on a variety of flatbed trailers while providing improved functionality.

As such, a need exists for an improved, more rapidly attachable railing system for flatbed truck that provides flexibility for use with a variety of different sized flatbed trucks.

### SUMMARY OF PREFERRED EMBODIMENTS

A railing assembly for use with a flatbed trailer is disclosed. The assembly includes cooperative posts that extend in an upwardly direction. A plurality of elongated member extending laterally between the cooperable posts. Each of the cooperable posts is supported on a caster system including a plurality of wheels enabling rolling movement of the railing assembly relative to a bed of the flatbed trailer. A platform assembly is disposed between the cooperable posts and the bed of the flatbed trailer. The platform assembly is pivotable relative to the cooperative posts between a lowered position for engaging the bed of the flatbed trailer and an elevated position for disengaging the bed of the flatbed trailer. For clarity, the bed of the flatbed trailer includes fixtures a related apparatus, slots, and the like to which the assembly may be secured.

The railing assembly of the present application provides a two-fold benefit to an operator. The railing assembly is moveable to engage the flatbed of the trailer while also providing a walking platform for an operator to access when working with content that is being removed from the flatbed or placed onto the flatbed. Existing railing assemblies to do not provide this contemplated amount of safety and flexibility that is anticipated to substantially improve productivity. Therefore, the invention of the present application provides necessary improvements over the prior railing assemblies that enhance productivity while also reducing a possibility of an operator fall from the flatbed trailer.

### BRIEF DESCRIPTION OF DRAWINGS

Advantages of the present disclosure will be readily appreciated as the same becomes better understood by reference to the following detailed description when considered in connection with the accompanying drawings:

FIG. 1 shows a perspective view of the rail assembly of the present invention;

FIG. 2 shows a front view of the rail assembly of the present invention;

FIG. 3 shows a rear view of the of the rail assembly of the present invention;

FIG. 4 shows a side view of the of the rail assembly having platforms disposed in an elevated position and a lowered position;

FIG. 5 shows a latch assembly; and

FIG. 6 shows a biasing spring and latch base of the latch assembly.

### DETAILED DESCRIPTION

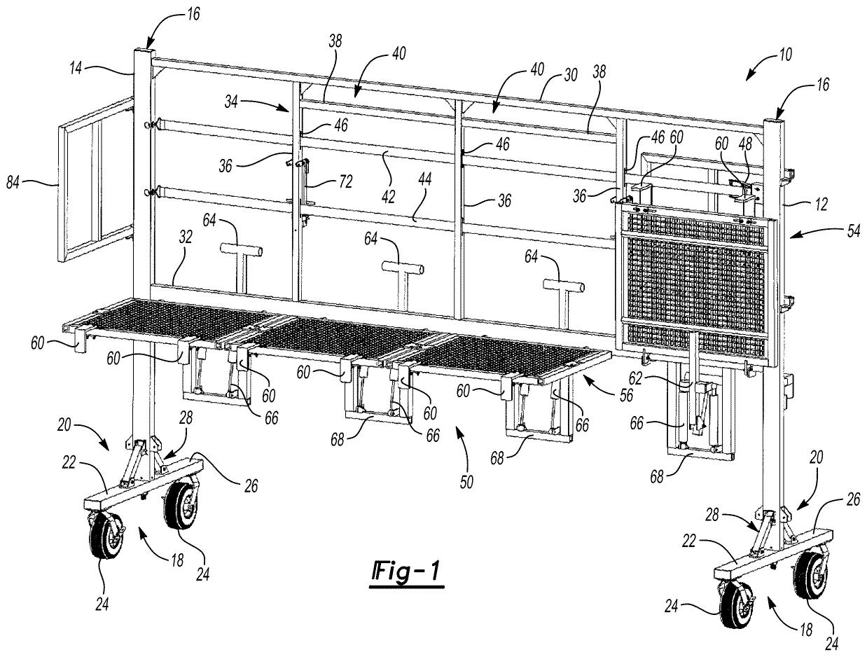

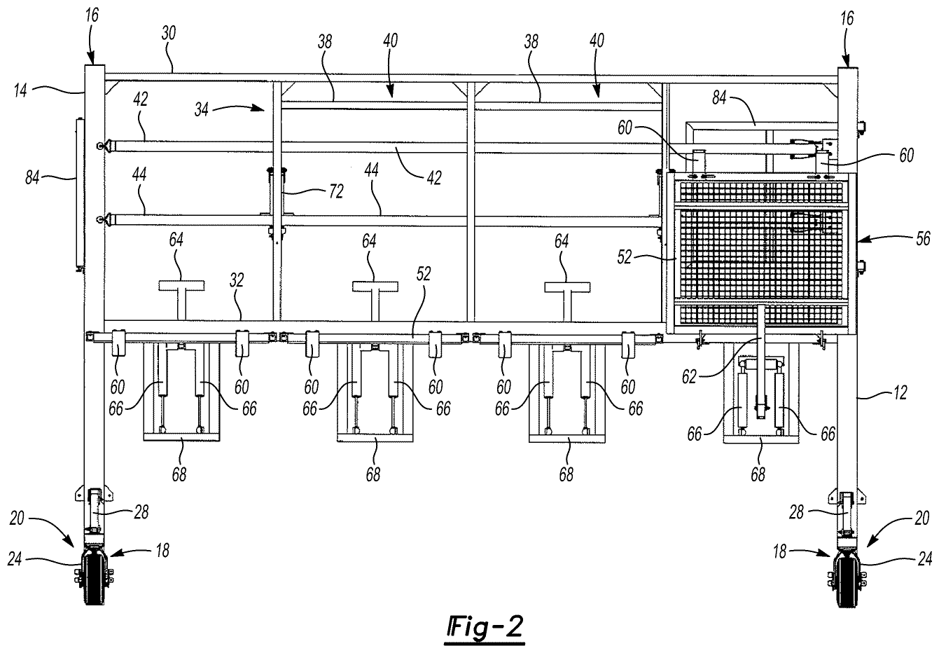

Referring to FIGS. 1-3, the assembly of the present invention is generally shown a 10. The assembly 10 includes a first post 12 and a second post 14 that act in a cooperative manner defining cooperative posts. Each post 12, 14 extend in an upwardly direction to a terminal end 16. The terminal end 16 is spaced above the flatbed of the trailer, the purpose of which will become more evident as the invention is explained further hereinbelow.

A caster system 18 is affixed to a proximal end 20 of each post 12, 14. The caster system 18 includes a plurality of casters 22, each including a plurality of wheels 24. In one embodiment, each post 12, 14 is supported by a caster 22. In alternative embodiments, a single caster 22 interconnects the posts 12, 14.

Each post 12, 14 is affixed to a caster arm 26 by a caster frame 28. In this embodiment each caster arm 26 is pivotally supported by two wheels 24 enabling the wheel axis to pivot relative to the caster arm 26 in a known manner.

The first post 12 is connected to the second post 14 by an upper rigid member 30 and a lower rigid member 32 defining a plurality of elongated members. The upper rigid member 30 and the lower rigid member 32 maintain the first post 12 and the second post 14 at a fixed distance apart.

The upper rigid member 20 supports a connecting frame 34 that includes a plurality of connecting elements 36 that interconnect the upper rigid member 30 to the lower rigid member 32. As such, the connecting elements 36 extend between the upper rigid member 30 to the lower rigid member 32 in a substantially vertical direction. A cross member 38 extends between adjacent connecting element 36 to define a lift slot 40 to receive an arm of a forklift for moving the assembly 10.

A first strap 42 and a second strap 44 extend between the first post 12 and the second post 14 and are therefore oriented substantially horizontally. In another embodiment only a first strap 42 is implemented. However, it should be understood by those of ordinary skill in the art that any number of straps may be implemented. Each strap 42, 44 passes through a strap slot 46 defined by the connecting elements 36. The straps are releasably engaged to the second post 14 and tightened by a ratchet 48 disposed upon the first post 12 as described in co-pending U.S. patent application Ser. No. 19/049,962, the contents of which are incorporated herein by reference and will not be explained further for brevity.

A platform assembly 50 extends from the lower rigid member 32 between the first post 12 and the second post 14. The platform assembly 50, in one embodiment, includes a plurality of platforms 52. Each platform 52 is pivotally connected to the lower rigid member 32 at a pivot 54 for pivoting between an elevated position 56 that orients the platform 52 in a substantially vertical position and a lowered position 58 that orients the platform in a substantially horizontal position.

A clasp 60 is disposed at an opposing side of each platform 52 from the pivot 54. In one embodiment, the plurality of clasps 60 is disposed at the opposing side of each platform 52 from the pivot 54. Each clasp defines an L-shaped section enabling the clasp 60 to engage a slot defined by the flatbed of the trailer to releasably secure the assembly 10 to the trailer when the platform 52 is disposed in a lowered position 58. Therefore, the platform assembly 50 is disposed at a same elevation as the flatbed when disposed in the lowered position 58. Therefore, when the platform is disposed in the lowered position, an operator may safely step between the platform assembly 50 and the flatbed.

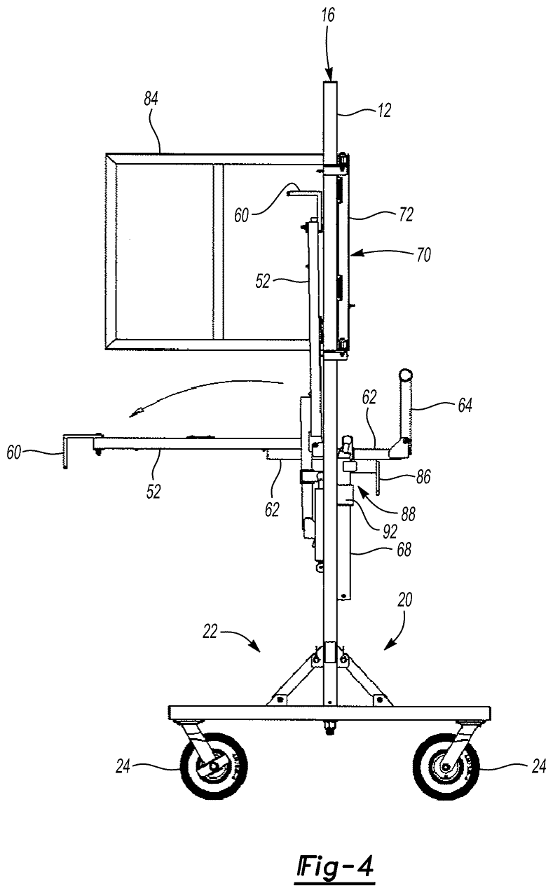

As best seen in FIG. 4, a lift arm 62 is affixed to each platform 52 extending beyond the pivot 54 to an opposite side of the lower rigid member 32 terminating at a handle 64. Thus, the lift arm 62 provides cantilevered movement to the platform 52 at the pivot 54. Thus, depressing the handle 64 moves the platform 52 to the elevated position 56 and releasing the handle 64 or pushing the handle in an upwardly direction causes the platform 52 to move to the lowered position 58. The handle 64 is optionally, pivotably connected to the lift arm 62 so that the handle 64, may be folded onto the lift arm 62 to a substantially vertical orientation when the platform 52 is disposed in the elevated position 56.

A biasing element 66 biases each platform 52 toward lowered position 58. In one embodiment, each platform 66 is connected to two biasing elements 66. However, any number of the biasing elements 66 may be implemented. A biasing frame 68 extends in a downward direction from the lower rigid member 32. Each biasing member 66 is affixed at one end to the biasing frame 68 and at an opposing end to a middle portion of the lift arm 62 from which biasing force is translated to the platform 52. Each platform 52 includes a designated biasing element 66 and biasing frame 68 that enables each platform 52 to be elevated or lowered independently from the other platforms 52.

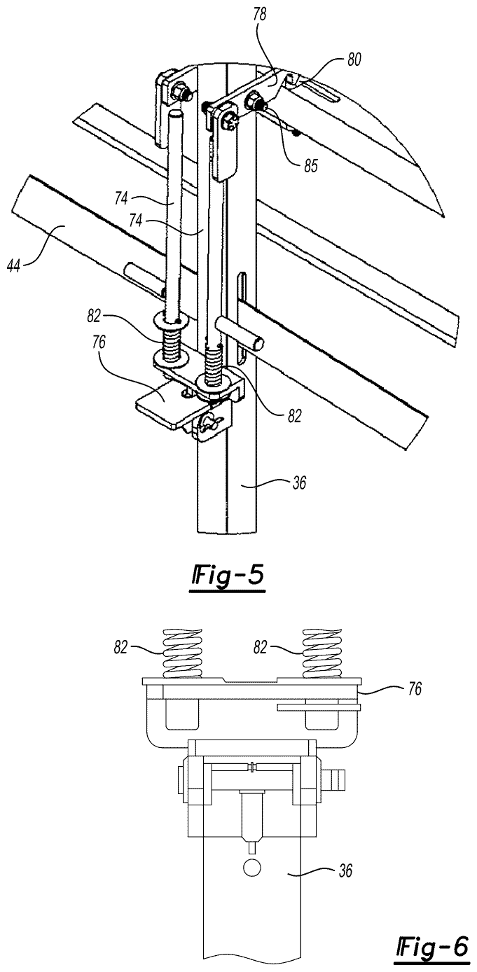

As best shown in FIGS. 5-6, a latch assembly 70 is affixed to each connecting element 36. Each latch assembly 70 includes cooperative latches 72 disposed upon opposite sides of its perspective connecting element 36. Each latch 72 includes a link 74 that extends upwardly from a latch base 76. The latch base 76 is fixedly attached to the connecting element 36 enabling the link 74 to extend in an upwardly direction. The link 74 is pivotally connected to a hook arm 78 that extend laterally from the link toward the platform 52 when the platform is disposed in the elevated position 56. The hook arm 78 includes a hook 80 that is disposed on an opposite end of the hook arm 78 from the link 74 and engages, or hooks, the platform 52 when the platform is disposed in the elevated position 56 for preventing the platform 52 from unintentionally falling toward the lowered position 58. Each link 74 is biased by a spring 82 or equivalent to bias the hook 78 into retaining engagement with the platform 52 when the platform 52 is fully disposed into the elevated position 56. More specifically, the hook arm 78 is pivotally attached to the connecting element 36 by a pivot fastener 85 enabling the hook arm to cantilever the hook 80 into retaining engagement with the platform 52 by the link 74 providing an upward force to the hook arm 78 by way of the spring 82.

A gate 84 is pivotally connected to each of the first post 12 and the second post 14. Thus, a gate 84 is disposed at opposing ends of the assembly 10. Each gate 84 spaced above the platform assembly 50 so that it pivots freely relative to each post 12, 14 enabling access to the platform assembly 50 from either end of the assembly. Each gate 84 is securable in a closed orientation to prevent egress from the ends of the assembly 10 when the assembly 10 is in use.

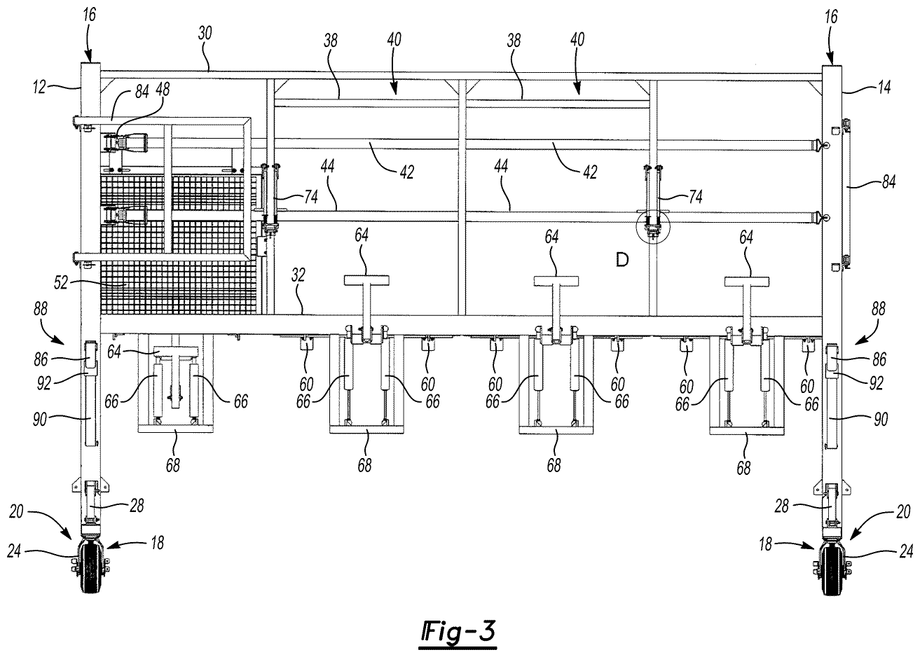

An alternative engagement system for mating the assembly 10 to a flatbed is provided when the platform assembly 50 is disposed in the elevated position 56. This embodiment is particularly useful when space is limited and orienting the platform assembly 50 in the lowered position 58 may not be practical. As best seen in FIGS. 3 and 4, an alternate clasp 86 is slidably affixed to each of the first post 12 and the second post 14. Each alternate clasp 86 is disposed upon an upper end 88 of a clasp rod 90. A retaining member 92 is fixedly attached to each post 12, 14 and defines an opening into which the clasp rod 90 is received providing slidable movement of the clasp rod 90 in a substantially parallel orientation with the post 12,14. The slidable movement provides for adjusting a height of the alternate clasp 86 to adjust to a height of the flatbed to secure the assembly 10 to the flatbed. It should be obvious to those of skill in the art that the alternate clasp 86 is disposed upon an opposite side of each post 12, 14 than from the platform assembly 50.

Obviously, many modifications and variations of the present invention are possible in light of the above teachings foregoing invention has been described in accordance with the relevant legal standards; thus, the description is merely exemplary rather than limiting in nature. Variations and modifications to the disclosed embodiment may become apparent to those skilled in the art and do come within the scope of the invention. Accordingly, the scope of the legal protection afforded this invention can only be determined by studying the following claims.

What is claimed is:

1. A railing assembly for use with a flatbed trailer, comprising:
cooperative posts extending in an upwardly direction;
a plurality of elongated member extending laterally between said cooperable posts;
each of said cooperable posts being supported on a caster system including a plurality of casters enabling rolling movement of said railing assembly relative to a bed of the flatbed trailer;
a platform assembly being disposed between said cooperative posts and the bed of the flatbed trailer, said platform assembly being pivotable relative to the cooperative posts between a lowered position for engaging the bed of the flatbed trailer and an elevated position for disengaging the bed of the flatbed trailer.

2. The assembly set forth in claim 1, wherein said flatbed trailer includes a connector and said platform assembly includes a clasp for releasably connecting said platform assembly to said flatbed trailer when said platform assembly is disposed in the lowered position.

3. The assembly set forth in claim 2, wherein said clasp includes a vertical element and a horizontal element intersecting to define an L-shaped section.

4. The assembly set forth in claim 1, wherein said platform assembly is pivotably connected to one of said elongated members extending between said cooperative posts thereby defining a pivot axis.

5. The assembly set forth in claim 4, further including an actuator extending outwardly from said platform assembly for applying pivotal movement of said platform assembly relative to said elongated member at said pivot axis.

6. The assembly set forth in claim 5, wherein said actuator includes a handle for providing downward pressure on said actuator for lifting said platform assembly to said elevated position and providing upward pressure on said actuator lower said platform assembly to said lowered position.

7. The assembly set forth in claim 6, further including a biasing member being engaged with said actuator for biasing said platform assembly in said lowered position.

8. The assembly set forth in claim 7, wherein said biasing member comprises a plurality of hydraulic pistons.

9. The assembly set forth in claim 6, wherein said handle is releasable from said actuator.

10. The assembly set forth in claim 1, wherein said platform assembly comprises a plurality of platforms extending between said cooperable posts.

11. The assembly set forth in claim 1, further including a clasp being biased to secure said platform assembly in said elevated position.

12. The assembly set forth in claim 1, further including a plurality of straps extending between said cooperable posts.

13. The assembly set forth in claim 12, wherein each of said plurality of straps is received by a slot defined by an intermediate frame disposed between said cooperable posts.

14. The assembly set forth in claim 13, wherein said intermediate frame is affixed to an upper elongated member and a lower elongated member, each extending between said cooperable posts thereby affixing said intermediate frame between said cooperable posts.

15. The assembly set forth in claim 1, further including an end frame being affixed to at least one of said cooperable posts and being laterally oriented to said plurality of elongated members.

16. The assembly set forth in claim 1, further including an alternate clasp being slidably affixed to each of said cooperative posts for engaging the flatbed trailer when said platform assembly is disposed in said elevated position.

17. The assembly set forth in claim 16, wherein said alternate clasp is slidable for adjusting a height of said alternate clasp relative to the flatbed trailer.
